(19) United States
(12) Patent Application Publication
(10) Pub. No.: US 2009/0271524 A1
(43) Pub. Date: Oct. 29, 2009

(54) Associating User Comments to Events Presented in a Media Stream

(76) Inventors: John Christopher Davi, Palo Alto, CA (US); Glenn Thomas Millican, III, Mountain View, CA (US); Marco Schmoecker, Oakland, CA (US); James Seung-Gyu Young, Oakland, CA (US); John Toebes, Cary, NC (US)

Correspondence Address: LEON R TURKEVICH, 2000 M STREET NW, 7TH FLOOR, WASHINGTON, DC, 200363307, US

(21) Appl. No.: 12/110,238

(22) Filed: Apr. 25, 2008

(51) Int. Cl. G06F 15/16

(52) U.S. Cl. 709/231

(57) ABSTRACT

In one embodiment, a method comprises collecting, by a server from a user device, a comment input by a user into the user device, the collecting including identifying a time that the user generated the comment; associating, by the server, the comment input by the user with an identifiable addressable media stream and at an identified position within the addressable media stream that is coincident with the time that the user generated the comment relative to an event presented in the addressable media stream; and generating and outputting by the server a media comment message that identifies the user, the comment generated by the user, the addressable media stream and the identified position within the addressable media stream coinciding with the time that the user generated the comment.

### TECHNICAL FIELD

The present disclosure generally relates to receiving, evaluating, and displaying user comments that are input by users of a data network, the comments relevant to a presentation consumed by the users. The presentation can be a live event such as a meeting or entertainment event that is viewed by the users, a televised event such as a network television show, or a prerecorded event such as a movie presentation.

### BACKGROUND

The convergence of telecommunications networks and Internet-based local and wide area networks has enabled users of these networks to employ different user input devices to convey messages to other users: such messages often can be stored for future retrieval or display indefinitely, for example at a website or a messaging server. Hence, these network users can send messages to a variety of destinations using any number of user input devices, including cell phones that enable text messaging (e.g., short message service (SMS)), Blackberry devices, wired or wireless personal computers, etc. Such user devices often can be used by users who wish to share opinions on different subjects.

Many network users are interested in sharing comments in real-time or near-real-time with respect to linear events experienced by the users, the linear events experienced either “live” or upon viewing (or hearing) an addressable media stream. A network user can utilize his or her input device to submit a comment expressing his or her opinion or reaction as to a particular event observed by the user: example events can include a controversial answer in a political debate, a sports team having completed a successful play, a dramatic event in a televised presentation, etc. Such user comments often can be submitted to Internet message boards (also referred to as “open threads” on social networking websites), instant messaging users, text messaging destinations, etc. Depending on the destination and the technology employed, the user comment may reach one destination user or multiple users simultaneously.

### BRIEF DESCRIPTION OF THE DRAWINGS

Reference is made to the attached drawings, wherein elements having the same reference numeral designations represent like elements throughout and wherein:

FIG. 1 illustrates an example system for associating comments input by a user with an event presented in an addressable media stream that has been consumed by the user, according to an example embodiment.

FIGS. 2A and 2B illustrate alternative example systems of FIG. 1 for associating comments input by a user with an event presented in the addressable media stream, according to other example embodiments.

FIG. 3 illustrates users commenting on events within an addressable media stream, according to an example embodiment.

FIGS. 4A and 4B illustrate an example method for associating a comment input by a user with an event presented in an addressable media stream, according to an example embodiment.

FIG. 5 illustrates an example media comment message output by an apparatus having associated a user comment with an event presented in an addressable media stream, according to an example embodiment.

FIG. 6 illustrates an example addressable media stream presented concurrently with with comments input by users, according to an example embodiment.

### DESCRIPTION OF EXAMPLE EMBODIMENTS

### Overview

In one embodiment, a method comprises collecting, by a server from a user device, a comment input by a user into the user device, the collecting including identifying the user and a time that the user generated the comment; associating, by the server, the comment input by the user with an identifiable addressable media stream and at an identified position within the addressable media stream that is coincident with the time that the user generated the comment relative to an event presented in the addressable media stream; and generating and outputting by the server a media comment message that identifies the user, the comment generated by the user, the addressable media stream and the identified position within the addressable media stream coinciding with the time that the user generated the comment.

In another embodiment, an apparatus comprises a device interface circuit configured for collecting, from a user device, a comment input by a user into the user device; and a processor circuit. The processor circuit is configured for identifying the user and a time that the user generated the comment. The processor circuit also is configured for associating the comment input by the user with an identifiable addressable media stream and at an identified position within the addressable media stream that is coincident with the time that the user generated the comment relative to an event presented in the addressable media stream. The processor circuit also is configured for generating a media comment message that identifies the user, the comment generated by the user, the addressable media stream and the identified position within the addressable media stream coinciding with the time that the user generated the comment. The device interface circuit further is configured for outputting the media comment message to a prescribed destination.

In yet another embodiment, an apparatus comprises a media controller circuit configured for causing an addressable media stream to be presented to a user of the apparatus from a media source that is distinct from the apparatus. The apparatus further comprises a comment input key responsive to input pressure by the user, and a comment circuit. The comment circuit is configured for identifying the user and recording a comment input by the user in response to detecting the input pressure of the comment input key by the user. The comment circuit also is configured for generating a comment message identifying the user and containing the comment. The apparatus further comprises a device interface circuit configured for outputting the comment message to a prescribed destination that associates the comment with an event presented in the addressable media stream and that is coincident with a time that the user input the comment.

### DETAILED DESCRIPTION

Particular embodiments disclosed herein enable a user comment to be associated with an event within an identifiable addressable media stream. The term “addressable” as used herein with respect to media streams refers to a media stream having attributes, for example a time index, that enables identification of a time instance relative to a fixed “point” (i.e., location or position) within the media stream. Hence, an addressable media stream can present a sequence of events that is deterministic and repeatable. An example of a media stream that is not an addressable media stream is a live broadcast which cannot be consumed at a later date.

The association of the user comment with the identified position within the identifiable addressable media stream can be preserved by a media comment message that associates the user and his or her comment to the position within the addressable media stream coinciding with the time the user input the comment. The media comment message thus preserves the user's reaction (expressed by the comment) to the event presented in the addressable media stream (the event identifiable by the position within the addressable media stream).

Multiple media comment messages from distinct users also can be collected by a prescribed destination. Hence, the independent and distinct media comment messages can be collected and applied for various applications, while preserving the integrity of each of the messages. For example, the collection of media comment messages enables the respective comments to be concurrently presented with the addressable media stream as the addressable media stream is presented to other users. Hence, a user that is viewing the addressable media stream can enjoy the experience of receiving multiple user comments associated with a given event within the addressable media stream. The concurrent presentation of the addressable media stream with the multiple user comments associated with the events within the addressable media stream can further enrich a user's experience as the user consumes (e.g., views or listens to) the addressable media stream. Hence, the concurrent presentation of the addressable media stream with the multiple user comments can increase the effectiveness or impact of interactive presentations such as political debates, virtual meetings, or distance learning. In contrast to existing systems (e.g., a video editor) that permit peer review and modification of metadata or an edit file associated with a video file, the media comment messages are “read only” (modifiable only by the user that created the comment), thereby preserving the integrity of the comment and the association with the addressable media stream. Further, existing video editors permit viewing and modification of an edit file by only a single person at a time. In contrast, the separate media comment messages can be collected, stored, sorted, filtered and concurrently presented with the addressable media stream. Hence, the collection of media comment messages, each preserving a user's corresponding reaction to an event in the addressable media stream, can result in a richer multimedia experience based on concurrent presentation of an event in the addressable media stream with the reactions by other users.

The particular embodiments also enable identification of a user's affinity or opinion toward an event within the addressable media stream, enabling an accumulation of “socially relevant gestures” that demonstrate the user's affinity toward various network items or network assets presented to the user. In particular, the act of a user generating a comment at a specific instance in response to experiencing an event presented by the addressable media stream can demonstrate a substantially strong opinion or preference by the user with respect to the event that has just been consumed (e.g., viewed or heard) by the user at that particular position of the addressable media stream.

For example, assume a user is viewing a network content asset in the form of a sports event, a movie, a televised political debate, or an episode of a dramatic television series via an addressable media stream. The addressable media stream can be downloaded from a network in the form of streaming media, or retrieved from a local storage medium such as a DVD. The user can have such a strong spontaneous and emotional reaction to a specific event presented in the addressable media stream that the user submits a comment via the network to a destination. The comment can be input by the user in the form of an instant message, a short message to a cell phone, a message posting to an online bulletin board, etc. Such a spontaneous and emotional reaction by the user to the specific event in the addressable media stream can be recorded based on identifying not only the user and the user comment, but also the “position” (e.g., time code) of the addressable media stream that identifies the event that is supplied to the user at the instant the user comment is detected. Hence, the spontaneous and emotional reaction by the user to the specific event in the addressable media stream can be recorded based on detecting the instance the user inputs the comment, coincident with the position of the addressable media stream that is being supplied for presentation to the user. An affinity by the user toward the event at the instance the user input the comment can be determined based on interpreting the comment relative to the event.

Hence, a media comment message can be generated that identifies the user, the comment generated by the user, the addressable media stream presented to the user, the identified position within the addressable media stream coinciding with the time that the user generated the comment, and/or an item affinity value that quantifies the affinity by the user toward at least one attribute of the event presented to the user at the identified position. The media comment message can be supplied to a system that can be configured for generating recommendations for the user based on accumulating socially relevant gestures that demonstrate preferences by the user. An example system that provides recommendations to users based on socially relevant gestures is disclosed in commonly-assigned, copending application Ser. No. 11/947,298, filed Nov. 29, 2007, entitled “Socially Collaborative Filtering”.

The media comment message that identifies the user, the comment generated by the user, the addressable media stream, the identified position within the addressable media stream coinciding with generation of the comment, and/or the item an affinity value also can be used to establish similarity relationships between users that spontaneously respond to the same event. The similarity relationships between users can be established based on determining that the respective comments sharing a determined positional similarity relative to the addressable media stream: an example positional similarity can be based on identifying a substantially large number of comments that have been input within a ten-second interval relative to an identifiable timecode of the addressable media stream. Hence, the similarity relationships can be established between multiple users that respond to the same event of the addressable media stream, without analyzing the actual content of the event that caused the users to input their comments. Hence, the similarity relationships can be established without the necessity of performing any predictive analysis of the content asset. Additional details regarding determining similarity relationships between users is described in further detail in the commonly-assigned patent application entitled “Identifying User Relationships from Situational Analysis of User Comments Made on Media Content” (Attorney Docket No 10-101), filed on even date herewith.

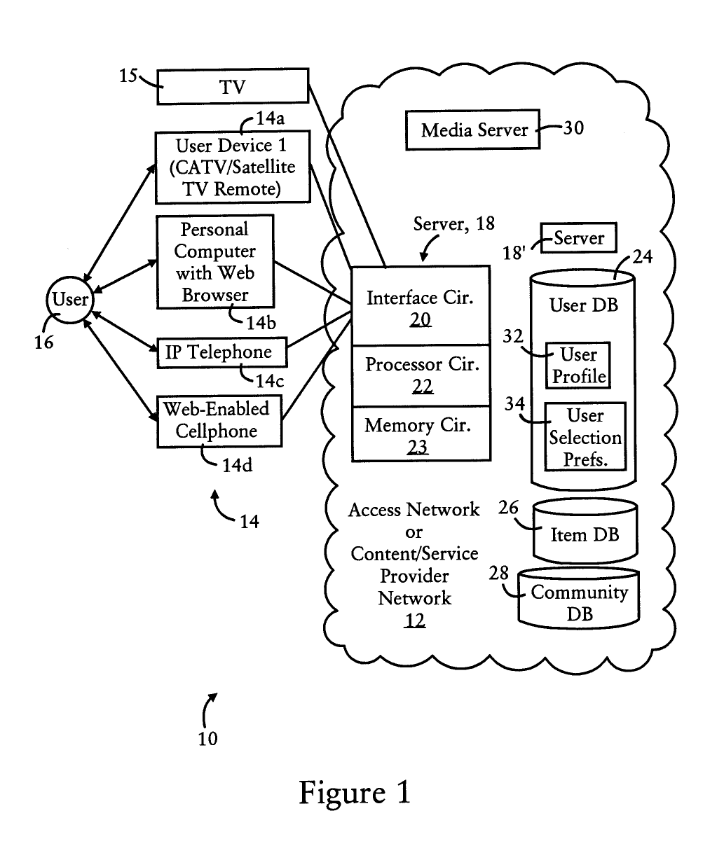

FIG. 1 illustrates an example system for associating user comments to events presented in an addressable media stream, according to an example embodiment. The system 10 includes a network 12 configured for detecting user selection inputs from user devices 14 under the control of an identifiable user 16. Example user devices 14 can include a remote control 14a for an intelligent digital television system 15 at the user premises, a personal computer 14b having a web browser, an IP based telephone 14c (for example, a voice over IP telephone), and/or a web enabled cell phone 14d. The IP telephone 14c and the web-enabled cell phone 14d also can include a web browser.

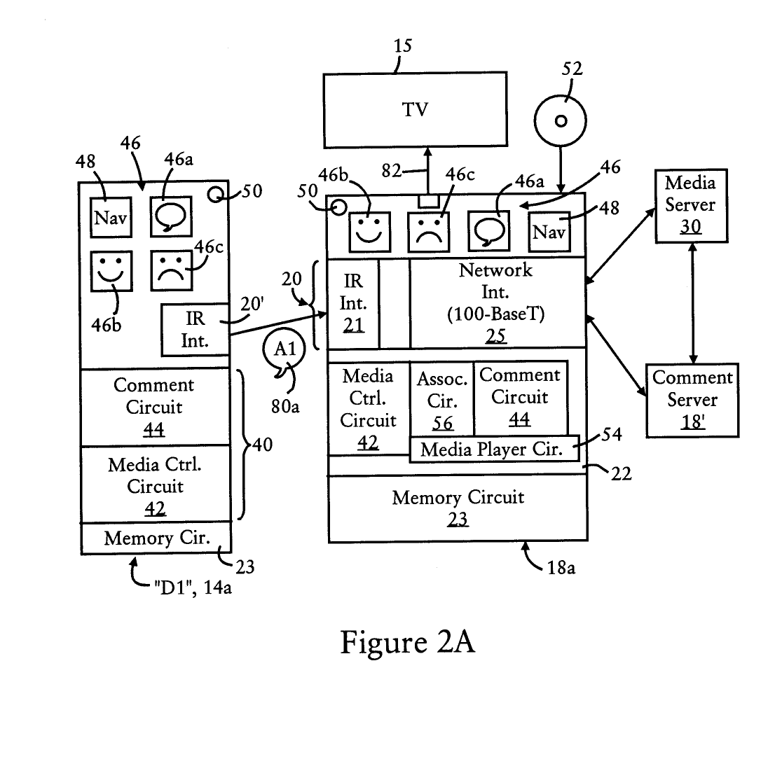

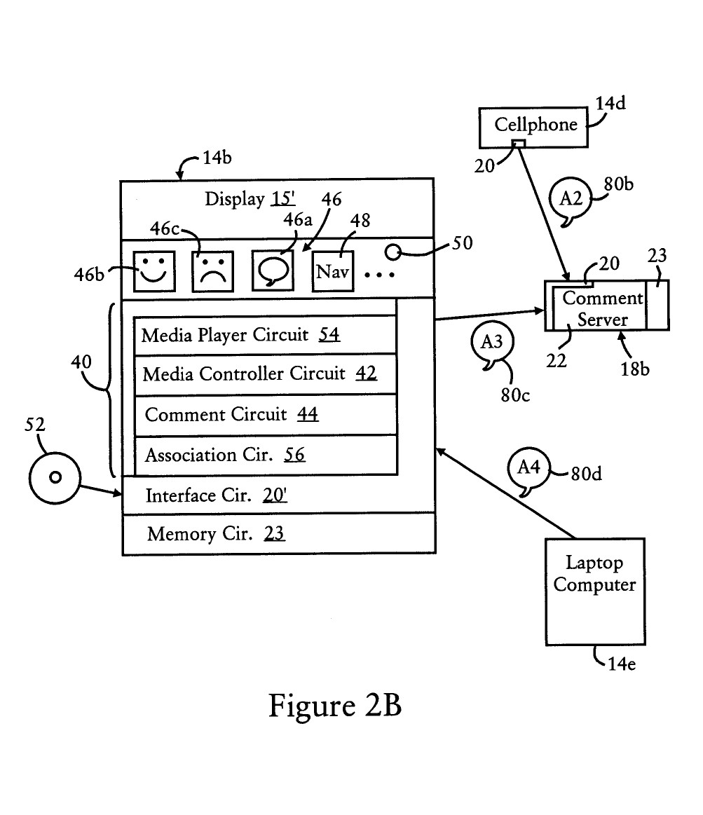

Any one of the user devices 14 can be configured for use by the user 16 to enter a comment in response to the user 16 reacting to an event that is “consumed” (e.g., viewed or heard) by the user 16. As described in further detail below with respect to FIGS. 2A and 2B, any user device 14 that is utilized as a user comment input device is configured for outputting the user comment to a prescribed destination, illustrated in FIG. 1 as the server 18, that can associate the comment with the event that is presented to the user 16. The server 18 also can associate the comment with the user witnessing a live event, and cause the comment to be associated with a prescribed addressable media stream that represents a broadcast of the live event (for example, a live political debate, a live performance or sporting event, etc.). Since the broadcasting of live events typically encounters a broadcast delay (e.g., seven seconds of delay between the live event and the broadcast presentation), the server 18 can use the corresponding delay to adjust the actual time of the comment input by the user 16 for concurrent presentation of the comment with the event that caused the user 16 to enter the comment. Note that use of a prescribed broadcast delay is not necessarily required for implementation.

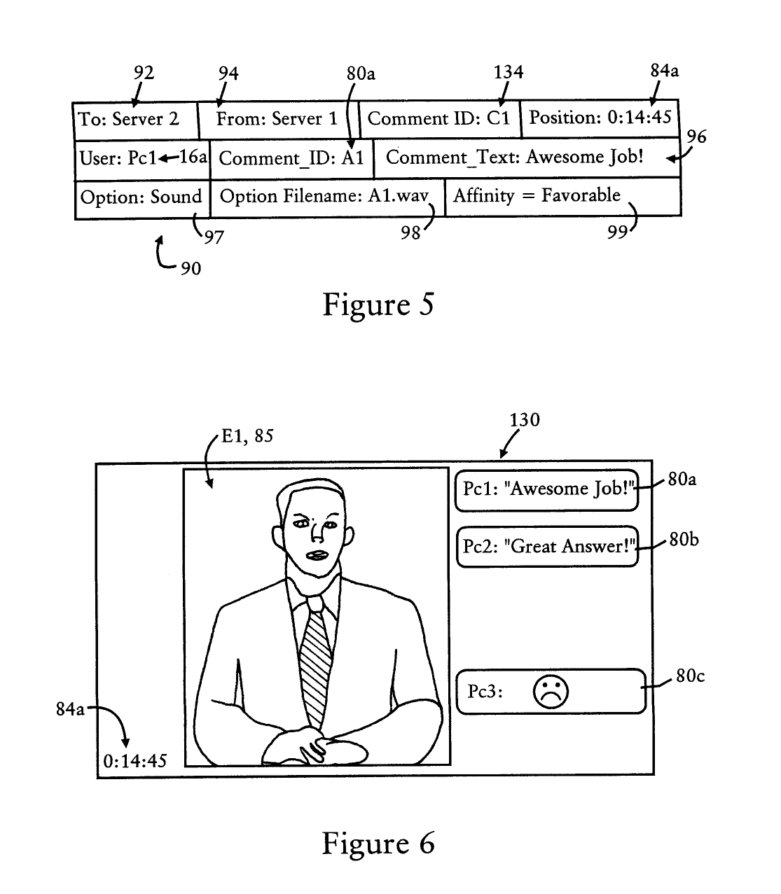

FIGS. 2A and 2B illustrates alternative example implementations of the user comment input device 14 and the server 18, according to example embodiments. The server 18 can be implemented in numerous forms, depending on the implementation of the user input device 14 that is used as the user comment input device. As illustrated in FIG. 2A, the server 18 can be implemented as a consumer set-top box 18a installed at a customer premises site and configured for supplying the media stream 82 to a consumer television 15, where the user comment input device (“D1”) can be implemented as a remote control device 14a. The server 18a also can be implemented as a customer premises router, for example a commercially-available Linksys® router. In the example of FIG. 2A, the server 18a can receive a comment 80a that is input into the user device 14a by the user 16, identify the user 16, associate the comment 80a with an identified position within the addressable media stream 82, and generate and output a media comment message 90 (illustrated in FIG. 5) that identifies the user 16, the comment (“A1”) 80a generated by the user, the addressable media stream 82 and the identified position within the addressable media stream 82 that coincides with the time that the user generated the comment. The server 16 of FIG. 2A can concurrently receive comments via other user comment input devices (not shown) from respective users at the same customer premises, for example other user remote-control devices 14a, a laptop computer 14b, etc.

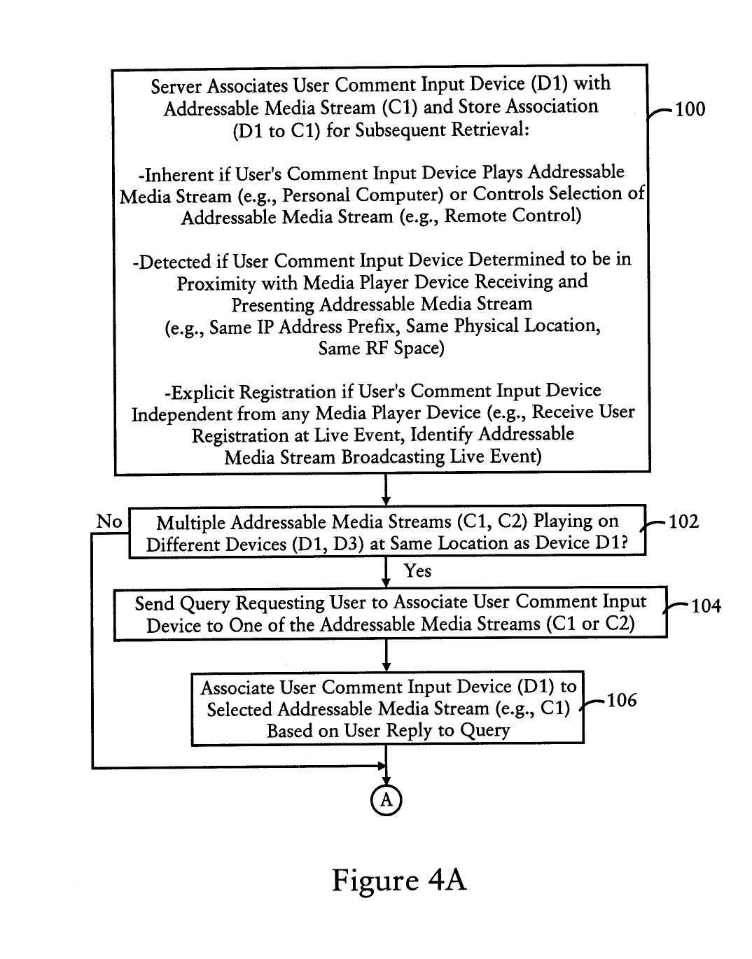

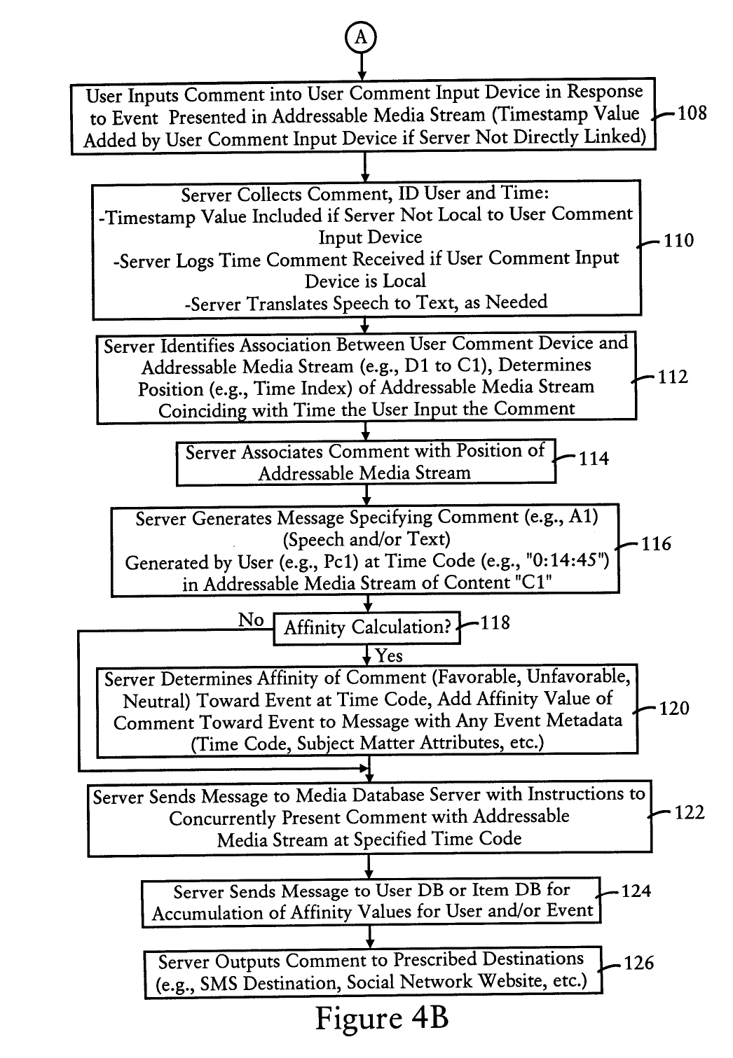

FIG. 2B illustrates alternative examples of user devices 14b and 14d that are utilized as user comment input devices configured for sending comment messages to a remote server 18b, according to example embodiments. The server 18b is reachable by the user devices 14b and/or 14d via the network 12 of FIG. 1. Hence, the comments 80 are transported within comment messages generated by the user device 14b and/or 14d if the associated server is not reachable via a direct local link. The example web-enabled cell phone 14d can output a comment message identifying the user 16 and containing the comment 80b to a prescribed destination 18b that is configured for associating the comment 80b with an event which is presented in an addressable media stream. As described in further detail below with respect to FIG. 4A, the comment server 18b can associate the comment 80b received from the cell phone 14d with a given addressable media stream based on the user 16 having performed a prior registration. For example, the server 18b can register the user via the corresponding user device 14d as witnessing a live event such as a sports event. Hence, the comment server 18b can associate the comment 80b to the corresponding broadcast of the live event, and associate the timestamp specified within the comment 80b with the corresponding position of the event within the addressable media stream that is broadcasting the live event.

FIG. 2B also illustrates an example user device 14b, for example a personal computer implemented for example as a laptop computer or some other personal communications device having a video display monitor 15′, where the user device 14b serves as both the user device that is presenting the addressable media stream and the user comment input device that is recording the comment (“A3”) 80c that is input by the user. As described in further detail below, the user device 14b can be implemented such that the presentation device portion 15′ presenting the addressable media stream is distinct and independent from the portion of the user comment input device that records the comment 80c, such that the user device 14b is incapable of performing the associating of the user comment 80c to the events presented in the addressable media stream 82: in this case, the user device 14b can be configured for outputting to the comment server 18b a comment message identifying the user and containing the comment 80c.

The comment server 18b can associate the comment 80c within the collected comment message with an addressable media stream and an identified position within the addressable media stream based on preregistration of the user device 14b by the user 16. The comment server 18b also can associate the comment 80c with the addressable media stream based on the server 18b detecting a proximity between the destination device for the addressable media stream being supplied by the network 12 to the user 16, and the source of the comment 80c. Hence, the comment server 18b can be configured for associating the comment 80c with a given addressable media stream based on detecting a proximity between a first device (e.g., 15) receiving the addressable media stream and the second device 14b supplying the comment 80c, even if the first and second devices are distinct from each other.

If desired, the user device 14b of FIG. 2B also can be configured as a server for at least one other local user device 14e based on including an association circuit 56 configured for associating the comment 80c with the event presented in the addressable media stream. Hence, the user device 14b can generate and output a media comment message that specifies the user, the comment 80c generated by the user, the addressable media stream presented to the user, and the identified position within the addressable media stream coinciding with the time that the user generated the comment. In this case, the user device 14b can be configured for outputting the media comment message to a prescribed destination that serves as a database server for accumulating the media comment message as a socially relevant gesture generated by the user and expressing an affinity toward the event in the addressable media stream.

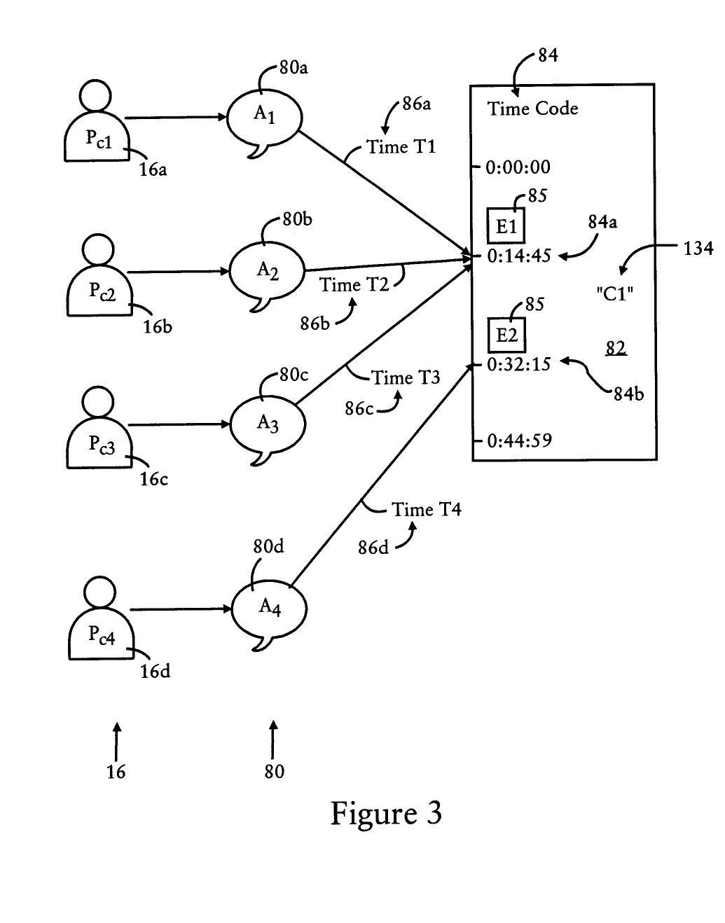

As illustrated in FIGS. 1, 2A and 2B, each example implementation of the server 18, including examples 18a and 18b, include a device interface circuit 20, a processor circuit 22, and a memory circuit 23. As described below with respect to FIGS. 3-6, each device interface circuit 20 is configured for collecting a comment 80 from a user 16 via a user comment input device 14.

Each processor circuit 22 can be configured for identifying a user 16 and a time 86 that the user 16 has generated a comment 80 received by the server 18, 18a or 18b, and associating the comment 80 input by the user 16 with an identifiable media stream 82 and at an identified position 84 that coincides with the time 86 that the user generated the comment 80 relative to an event 85 presented in the addressable media stream 82. Each processor circuit 22 also can be configured for generating and outputting a media comment message 90, illustrated in FIG. 5, that identifies the user 16, the comment 80 generated by the user, the addressable media stream 82 by its corresponding identifier 134, and the position 84 within the addressable media stream 82 that coincides with the time 86 that the user 16 generated the corresponding comment 80. The device interface circuit 20 can be configured for outputting the media comment message 90 to various prescribed destinations depending on the application, for example to another user device for enhanced multimedia instant messaging communications between users, to a social network website messaging board, to a media server 30 for concurrently presenting the comment 80 with the addressable media data stream 82, and/or to a database 24 or 26 for accumulation of socially relevant gestures demonstrating affinity by the user 16 toward the event 85.

As illustrated in FIG. 2A, the server 18a can be configured to associate the comment 80a input by a user 16 via a distinct user device (“D1”) 14a. In particular, the user comment input device (“D1”) 14a can include a processor circuit 40 that includes a media controller circuit 42 and a comment circuit 44. The user comment input device 14a also can include a memory circuit 23, one or more comment input keys 46 for entering user comments, one or more navigation keys 48, a microphone 50 for entering spoken comments, and a device interface circuit 20′ configured for outputting the comment 80 input by the user 16.

The comment input keys 46 (for example, comment input keys 46a, 46b, and/or 46c) can be configured for enabling a user to input a corresponding input based on applying a prescribed input pressure to the corresponding key 46. The comment circuit 44 can be configured for recording the comment input by the user 16 in response to detecting the corresponding input pressure of the corresponding comment input key 46 that is input by the user 16. For example, the user 16 can press a recording input key 46a, for example an audio input key that also can be referred to as a “scream” key 46a, that causes the comment circuit 44 to record an audible comment by the user 16 that is detected by an internal microphone 50 while the user depresses the audio input key 46a: in response to detecting that the user has released the audio input key 46a, the comment circuit 44 can cease recording and forward the audible comment 80a to the server 18a via a wireless device interface 20′, for example an infrared (IR) interface. Alternately, the comment circuit 44 can be configured to simultaneously record and stream an audio stream input to the server 18a, starting in response to the user depressing the audio input key 46a and stopping in response to the user releasing the audio input key 46a. The comment circuit 44 also can be implemented to record digital images or videos, for example if the microphone 50 is supplemented with a built-in camera that can record images or videos; hence, the recorded comment can be stored as audio, image, or video, depending on implementation.

The comment circuit 44 also can be configured for detecting if a user has pressed a prescribed comment input key 46b that is assigned to represent a favorable opinion (illustrated on the key 46b in the form of a smiling face), or a prescribed comment input key 46c that is assigned to represent an unfavorable opinion (illustrated on the key 46c as a frowning face). Hence, the comment circuit 44 can be configured for outputting the corresponding comment 80 based on whether the user has input a favorable comment input key 46b or an unfavorable comment input key 46c. As apparent from the foregoing, the input keys 46 are configured to enable a user to provide near instantaneous feedback during presentation of the addressable media stream 82, since a user may have limited time to enter detailed comments, depending on the context of the addressable media stream 82.

The navigation key 48 (illustrated as a single key for simplicity) can be configured for selection of the addressable media stream to be presented, for example changing channels, where the media controller circuit 42 sends control inputs to the server 18a: the media player circuit 54 in the server 18a, in response to the control inputs, presents the addressable media stream 82 to the display device 15 viewed by the user 16. The addressable media stream also can be stored locally, for example on a tangible storage medium such as a DVD-ROM 52 or in the memory circuit 22

As illustrated in FIG. 2A, the device interface circuit 20 of the server 18a (implemented for example as a set-top box residing at the customer premises) can include an infrared interface circuit 21 and a network interface circuit 25 (implemented for example as a 100 Mb per second Ethernet or 100-Base T interface circuit): the infrared interface circuit 21 is configured for collecting the comment 80a input by the user 16 from the user device (“D1”) 14a. The processor circuit 22 within the server 18a can include an association circuit 56 configured for associating the comment 80a input by the user 16 with the addressable media stream 82 that is being presented to the user 16. In particular, the association circuit 56 can identify the user 16, for example based on the user providing via the user input device 14a a prescribed registration such as a prescribed alias, a prescribed input key sequence assigned to the user 16, or Personal Identification (PIN) number. If a user input device 14 is assigned to a unique user, a unique device identifier also can be used to identify the user. The “identification” of the user 16 as described herein does not necessarily require determining the user's personal identity, but simply requires some identifier or “alias” that can distinguish the user from other users.

The association circuit 56 also can identify the time 86a that the user generated the comment 80a based on determining from an internal system clock the time that the interface circuit 21 received the comment 80a from the user comment input device 14a. In response to identifying the time 86a that the user 16 generated the comment via the user comment input device 14a, the association circuit 56 within the processor circuit 22 can identify the identified position 84 within the addressable media stream 82 that coincides with the time 86a that the user generated the comment 80a relative to an event 85 presented in the addressable media stream 82.

FIG. 3 illustrates an example association that can be executed by the server 18a of FIG. 2A, the server 18b of FIG. 2B, or the server 18 of FIG. 1, where the server 18 can record the comments input by multiple users utilizing respective user comment input devices 14. Alternately, the users 16 can be located at different locations and submit their respective comments 80 via respective IP-based comment messages using their respective user comment input devices 14. The comment messages can be output either to the same server 18 via an Internet Protocol (IP)-based connection, or to distinct distributed servers 18 that generate and store respective media comment messages 90 in the databases of FIG. 1.

As illustrated in FIG. 3, the association circuit 56 within the processor circuit 22 of the server 18a of FIG. 2A can detect that the time instance 86a that the user 16a inputs the comment 80a is coincident with presentation to the user 16a of the event (“E1”) 85 at the identified position 84a of the addressable media stream (“C1”) 82, illustrated as the timecode “0:14:45”. Assuming that the users 16b, 16c and 16d are located at distinct locations and communicate with respective servers 18a, the association circuit 56 in each of the respective servers 18a associate the respective comments 80b, 80c, and 80d with the addressable media stream (“C1”) 82 as coinciding with the respective positions based on the respective time instances 86b, 86c, and 86d that the users input the comments. As illustrated in FIG. 3, the comments 80a, 80b, and 80c can coincide with the same position 84a of the addressable media stream (“C1”) 82 since the time instances 86a, 86b, and 86c of the respective users 16a, 16b, and 16c are essentially identical in response to the event “E1” 85. In contrast, the association circuit 56 for the server 18a collecting the comment 80d at the time instance 86d associates the comment 80d with the addressable media stream “C1” 82 and coinciding with the comment “E2” at position 84b.

As illustrated in FIG. 5, the association circuit 56 can generate a media comment message 90 for each corresponding comment 80. The media comment message 90 for the corresponding comment 80 can be output by the network interface circuit 25 of the device interface circuit 20 (or 20′ of FIG. 2B) to a prescribed destination, for example for storage in a database 24, 26, and/or 28 as a socially relevant gesture by the user 16. The media comment message 90 also can be output by the device interface circuit 20 or 20′ to a prescribed destination (e.g., any one of the databases 24, 26, or 28) that collects the media comment messages 90. The collected media comment messages 90 can be retrieved (e.g., from database 26) by the media server 30 for concurrent presentation of the comments 80 (e.g., 80a, 80b, and 80c) with the associated event “E1” 85 at the position 84a within addressable media stream 82, illustrated in FIG. 6. The concurrent presentation of the comments 80a, 80b, and 80c with the addressable media stream can be implemented by the media server 30, for example, during a televised broadcast where spectators 16a, 16b, and 16c at a live sports event each independently enter the respective comments 80a, 80b, and 80c in response to witnessing the event “E1” 85 in person.

As illustrated in FIG. 2A, the server 18a, implemented as a consumer set-top box, also can be configured for including the input keys 46 and 48 for direct input by a user 16; hence, the server 18a also can be configured for including the media control circuit 42 and the comment circuit 44 for local control by the user 16. In this example, the comment circuit 44 within the processor circuit 22 can pass the comment directly to the association circuit 56 via a hardware connection.

As illustrated in FIG. 2B, the user device 14b also can include a processor circuit 40, a device interface circuit 20′, and a memory circuit 23. The processor circuit 40 of the user device 14b can include a media controller circuit 42 and a media player circuit 54 for controlled presentation of an addressable media stream 82. The addressable media stream can be received as streaming media via the interface circuit 20′, for example via an Internet connection, or retrieved from a local tangible storage medium such as a DVD-ROM 52.

Hence, a user of the device 14b can use the same device 14 for viewing the addressable media stream 82, and inputting comments using the comment input keys 46a, 46b, and/or 46c. The comment circuit 44 responds to the user pressing the comment input keys 46 by recording the comment input by the user, causing the interface circuit 20′ to output the comment 80 to a prescribed destination (e.g., the comment server 18b) that associates the comment with the event presented in the addressable media stream coincident with the time that the user input the comment. If the prescribed destination (e.g., the comment server 18b) is remotely reachable via a data network, the comment circuit 44 and/or the interface circuit 20′ can be configured for generating a unique identifier for identifying the user 16, and generating a comment message specifying the unique identifier for identifying the user, the comment 80, and a time stamp indicating a time that the comment was input by the user. Alternatively, the association circuit 56 illustrated in the server 18a of FIG. 2A also can be implemented within the user device 14b, enabling the user device 14b to generate and output the media comment message 90 illustrated in FIG. 5. As described previously, the device 14b can act as a server for other user devices 14e that forward their comment messages to the device 14b.

As illustrated in FIG. 1, the server 18 can be configured for accessing databases 24, 26, and/or 28. The example server 18 can be implemented as a single server that can be implemented at the head end of an access network 12 for a content provider offering content services to the user 16, the access network 12 providing access to other content or service providers 30 via a wide area network such as the Internet. The example server 18 also can be implemented as a distributed server system within the network 12, where a first server (e.g., 18) within the distributed server system associates the comments 80 to events 85 within an addressable media stream 82 and generates the media comment message 90 of FIG. 5, and a second server (e.g., 18′) within the distributed server system manages distribution and implementation of the media comment message 90, for example updating the databases 24, 26, and 28 based on the media comment message 90 in order to forward the comment 80 to other users or destinations, or cause the comment 80 to be concurrently presented with the addressable media stream 82.

Hence, the example server 18 can be implemented as a single, integrated server implemented at a customer premises or within a wide area network infrastructure; the server 18 also can be implemented in a distributed server system implemented within an access network locally reachable by the user devices 14, or a distributed server system implemented within a content provider network that is remotely reachable by the user devices via a wide area network.

The server 18 can update the user database 24, the item database 26, and/or the community database 28 based on the media comment message 90 describing the comment 80 generated relative to the event 85 at the identified position 84 within the addressable media stream 82. The user database 24 can be configured for storing information related to the user 16, including a user profile 32 and user selection preferences 34. The user profile 32 can include information about the user 16, including personal account subscription information related to establishment and maintenance of any network service utilized by the network devices 14, identification of other network users that have a close relationship with the identified user 16 (e.g., “buddy lists” for instant messaging sessions or cell phone subscriptions), or users of online forums that the user 16 has identified as being “favorite” users or “disliked” users. The user selection preferences 34 can illustrate the socially relevant gestures of the identified user 16 based on an accumulation of the user selection inputs executed by the identified user 16 relative to the context of those user selection inputs, for example the media comment message 90 identifying the event 85 as the context for the addressable media stream 82.

The item database 26 can be configured for storing information about network items that are available for presentation to the user, including item-to-user relationships that can correlate the affinity values for all users having commented on a given asset such as the event 85 within the addressable media stream 82. The community database 28 can include information identifying relationships between the identified user 16 and other elements of a community-based network service, for example messaging boards, Internet-based recommendation sites, Internet-based social community websites, etc., where the identified user 16 can identify himself or herself as having particular preferences in terms of political interests, hobbies, “favorite” users, “disliked” users, preferred content, or content to avoid.

Any one of the disclosed circuits of any disclosed server 18 (including the network interface circuit 20, the processor circuit 22, and/or the memory circuit 23, as well as their associated components), or any of the disclosed circuits of the any disclosed user input device 14, can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of the disclosed circuits also can be implemented using a software-based executable resource that is executed by a corresponding internal processor circuit such as a microprocessor circuit (not shown), where execution of executable code stored in an internal memory circuit (for example, within the memory circuit) causes the processor circuit to store application state variables in processor memory, creating an executable application resource (for example, an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor. Any disclosed memory circuit can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a tangible memory medium in the disclosed apparatus (for example, in a transmit buffer). Any reference to “outputting a message” or “outputting a packet” (or the like) also can include electrically transmitting (for example, via wired electric current or wireless electric field, as appropriate) the message/packet stored in the tangible memory medium to another network node via a communications medium (for example, a wired or wireless link, as appropriate) (optical transmission also can be used, as appropriate). Similarly, any reference to “collecting a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (for example, in a receive buffer). Also note that the memory circuit 23 can be implemented dynamically by the processor circuit 22, for example based on memory address assignment and partitioning executed by the processor circuit 22. In addition, the processor circuit 22 can be implemented as a multi-processor system or based on a distributed server system.

FIGS. 4A and 4B illustrate an example method by any of the disclosed servers 18 of associating comments input by users with an event presented in an addressable media stream, according to an example embodiment. The steps described in FIGS. 4A and 4B can be implemented as executable code or encoded logic stored on a tangible computer readable storage medium (for example, floppy disk, hard disk, ROM, EEPROM, nonvolatile RAM, CD-ROM, etc.) that are completed based on execution of the code by a processor; the steps described herein also can be implemented as executable logic that is encoded in one or more tangible media for execution (for example, programmable logic arrays or devices, field programmable gate arrays, programmable array logic, application specific integrated circuits, etc.).

As illustrated in FIG. 4A, the processor circuit 22 of the server 18 associates in step 100 a user comment input device (e.g., “D1”) 14a with a given addressable media stream (“C1”) 82, and stores the association between the user input device (“D1”) 14a and the addressable media stream (“C1”) 82 for subsequent retrieval as the user inputs comments 80. The manner in which the association is executed in step 100 can depend on the implementation of the user comment input device 14 relative to the server 18. For example, if as illustrated in FIG. 2A or FIG. 2B the user comment input device either plays the addressable media stream 82 (for example the personal computer 14b) or controls selection of the addressable media stream 82 (for example the remote control 14a), the processor circuit 22 can inherently associate the user comment input device with the addressable media stream 82 that is being presented. For example, the processor circuit 22 in the set-top box 18a can inherently associate the device 14a with the addressable media stream “C1” 82 because the set-top box 18a currently is presenting the addressable media stream “C1” 82 to the display 15; in the example of the user computer 14b, if the user computer 14b is receiving the addressable media stream 82 via an IP-based connection via the network 12, processor circuit 22 in the server 18b that receives the comment 80c can determine that the user device 14b is currently receiving the addressable media stream “C1” 82.

Referring to FIG. 1, if the server 18 is implemented within the access network 12, the processor circuit 22 within the server 18 also can associate a user comment device (e.g., 14b) with the addressable media stream (“C1”) 82 based on detecting that the user comment input device 14b is in proximity with the media player device (for example, the television 15) that is receiving and presenting the addressable media stream (“C1”) 82 to the user 16. In other words, the processor circuit 22 within the server 18 can detect that the user 16 is viewing the addressable media stream 82 via a user device 15 that is distinct from the user comment input device 14b. Depending on implementation, the server 18 can identify the proximity between the user comment input device 14b and the media player device 15 based on various attributes, for example if both user devices 14b and 15 are within the same IP address prefix (assigned to a single household or apartment), the same physical location, or the same radio frequency space.

The server 18 also can associate the user comment input device, for example the cell phone 14d of FIGS. 1 or 2B, based on the user 16 executing an explicit registration of the user comment input device 14d independent of any media player device. The explicit registration between the user 16 and the comment server 18 can be particularly effective in enabling the user to comment on live events, for example sports events that the user is witnessing in person. In this example, the processor circuit 22 can identify the addressable media stream corresponding to the broadcast of the live event that is being witnessed by the user 16, for example based on accessing a directory server that identifies the addressable media streams for respective broadcast events.

If in step 102 the processor circuit 22 detects a second addressable media stream (e.g., “C2”) 82 is being supplied to another user device 14d that is within the detected proximity between the user's other registered devices 14b and 15, the processor circuit 22 within the server 18 can send in step 104 a query to the user requesting that the user manually associate the user comment input device relative to either the first addressable media stream (“C1”) or the second addressable media stream (“C2”). The processor circuit 22 within the server 18 can then associate in step 106 the user comment input device 14b to the selected addressable media stream (e.g., “C1”) in response to the reply to the query received from the user 16.

After the user input device 14 has been associated with the addressable media stream (e.g., “C1”), the association circuit 56 within the processor circuit 22 of the server 18 can begin associating comments 80 input by the user 16 to identifiable positions 84 of the addressable media stream 82. As apparent from the foregoing, the steps of FIG. 4A can be repeated for each user comment input device.

Referring to FIG. 4B, assume the user 16a inputs in step 108 a comment into his or her user comment input device 14a of FIG. 2A in response to an event “E1” 85 observed by the user 16a. The comment circuit 44 of the user comment input device 14a records the comment 80 and outputs the comment via the corresponding device interface 20′: if the user comment input device is not directly linked with the server 18, the user comment input device 14 can be configured to generate a timestamp value indicating the time that the user entered the comment, and generate and output a comment message specifying an identifier identifying the user, the comment 80, and the timestamp value.

The device interface circuit 20 of the server 18 collects in step 110 the comment 80, and identifies the user and the time that the user generated the comment 80: if no timestamp is included, for example if the user comment input device is a local device, the association circuit 56 can log the time that the comment is received. If the user comment input device is a local device, the association circuit 56 also can identify the user for example using a device identifier of the user comment input device, or based on the user having previously supplied a unique registration key sequence. As described previously, if the user comment input device 14 is not local to the server, then the user comment input device 14 typically will output a comment message including a user identifier, a timestamp value, and the comment 80. The association circuit 56 also can forward the comment 80 to a speech to text translation resource if the comment is implemented as an audible comment.

The association circuit 56 identifies in step 112 the association between the user comment input device 14 and the chosen addressable media stream based on retrieving the association for the user comment input device 14 as described above with respect to FIG. 4A, and determines in step 112 the position (e.g., 84a) in the addressable media stream 82 that coincides with the time instance 86a that the user 16a input the comment 80a. As illustrated in FIG. 3, the association circuit 56 can determine that the comment 80a was input by the identified user 16a at the time instance 86a coinciding with the position (“0:14:45”) 84a of the addressable media stream “C1” 82. Hence, the association circuit 56 within the processor circuit 22 of the server 18 creates the association in step 114 between the comment 80a and the position 84a in the addressable media stream 82. The association circuit 56 within the server 18 generates in step 116 the media comment message 90, illustrated in FIG. 5.

As illustrated in FIG. 5, the media comment message 90 generated by the association circuit 56 specifies a destination field 92 that specifies the destination of the media comment message 90, a source field 94 specifying the server 18 that generated the media comment message 90, a content identifier 134 identifying the addressable media stream “C1” 82, a position identifier that identifies the position 84a of the identified addressable media stream “C1” 82 for the identified comment 80a. The media comment message 90 also identifies the user 16a, and can include the text 96 of the comment 80a, for example utilizing speech to text translation or prescribed text messages generated in response to the user pressing “shortcut” keys. The media comment message 90 also can include an option field 97 identifying whether a user-generated media file 98 is attached, for example an audio file for an audio-based comment, an image file for an image-based picture comment (e.g., a graphical image of a smiley face or an angry face or a user-personalized image), or a video file for a video-based comment. The source field 94 and the destination field 92 also can be added to the media comment message 90 by the device interface circuit 20 or 20′ according to the protocol used to send the media comment message 90 (e.g., TCP/IP).

As illustrated in FIG. 4B, the association circuit 56 also can be configured for executing in step 118 an affinity calculation that interprets in step 120 whether the comment 80a is favorable, unfavorable, or neutral toward the event “E1” at the identified timecode 84a. The association circuit 56 can add in step 120 the affinity value 99 to the media comment message 90, plus any desired metadata related to the event, as desired. Note that is not necessary for the actual event 85 to be interpreted.

In response to the association circuit 56 of the processor circuit 22 in the server 18 generating the media comment message 90, the device interface circuit 20 in step 122 can output the message 90 to prescribed destinations, as appropriate. For example, the device interface circuit 20 can output in step 122 the 92 media comment message 90 to a media database server, illustrated for example as the media server 30 of FIGS. 1 or 2A, with instructions to concurrently present the comment 80a with the addressable media stream “C1” 82 at the specified time code 84a. As illustrated in FIG. 6, the accumulation of multiple comments 80a, 80b, and 80c relative to the position 84a enables the media server 30 to present the addressable media stream “C1” 82 in combination with the comments 80a, 80b, and 80c that are presented concurrently with the event “E1” 85 at the position 84a, resulting in a richer multimedia presentation 130. As described previously, the comments 80a, 80b, and 80c may have been generated by users witnessing a live performance of the event 85, such that the multimedia presentation 130 can be presented to other users during broadcasting of the live event; alternately, the messages 90 associated with the respective comments 80 can be stored in the item database 26 of FIG. 1, enabling the media server 30 to retrieve the comments 80 as needed during subsequent presentations of the addressable media stream 82. Note that if a comment (e.g., 80c) is implemented as a video comment, the video comment can be presented concurrently with the event 85, for example in a separate display window of the multimedia presentation 130, within a picture-in-picture window, etc.

The device interface circuit 20 also can send in step 124 the message 94 the corresponding comment 80 to the user database 24 and/or the item database 124 for storage of the comment 80 as a socially relevant gesture toward the event 85 occurring at the corresponding position 84a of the addressable media stream 82. As described previously, the accumulation of socially relevant gestures can be used to identify user preferences and potential recommendations for the user for network content that can be determined as most appropriate for the user.

The device interface circuit 20 also can send in step 126 the media comment message 90 containing the comment 80 to a prescribed destination user device according to a prescribed messaging protocol, for example short message service, a social network website, an instant messaging client, etc., enabling a destination user that is also viewing the same addressable media stream 82 to consume the comment 80 coincident with the presentation of the corresponding event 85 at the corresponding position 84a. As apparent from the foregoing, the steps of FIG. 4B can be repeated for each comment 80 input by a user.

According to the example embodiments, comments entered by a user via any user comment input device can automatically be associated not only with a particular addressable media stream that is being consumed by the user, but the comment also can automatically be associated with an identified position within the addressable media stream that is coincident with the time that the user generated the comment relative to an event presented in the addressable media stream. Hence, the context of the comments relative to the event presented within the addressable media stream is preserved, enabling the comment to be concurrently presented with future presentations of the addressable media stream, applying the comment as a socially relevant gesture identifying an affinity toward the event within the addressable media stream, or presenting the comment to other users at the time the event appears to the other users consuming the addressable media stream.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
collecting, by a server from a user device, a comment input by a user into the user device, the collecting including identifying the user and a time that the user generated the comment;
associating, by the server, the comment input by the user with an identifiable addressable media stream and at an identified position within the addressable media stream that is coincident with the time that the user generated the comment relative to an event presented in the addressable media stream; and
generating and outputting by the server a media comment message that identifies the user, the comment generated by the user, the addressable media stream and the identified position within the addressable media stream coinciding with the time that the user generated the comment.

2. The method of claim 1, wherein the associating includes:
registering the user, via the user device, as witnessing a live event; and
identifying the addressable media stream as a broadcast of the live event;
the identifying the time that the user generated the comment based on detecting a timestamp value supplied with the comment from the user device and identifying the time that the user generated the comment.

3. The method of claim 1, wherein the associating includes detecting that the user is viewing the addressable media stream via a second user device distinct from the user device.

4. The method of claim 3, wherein the associating includes associating the user device as a comment input device for the addressable media stream supplied to the second user device, based on the server identifying a determined proximity between the user device and the second user device as the addressable media stream is supplied to the second user device.

5. The method of claim 4, further comprising the server detecting a second addressable media stream supplied to a third user device within the determined proximity between the user device and the second user device, the associating further comprising:
sending a query to the user for associating the user device as the comment input device for one of the addressable media stream or the second addressable media stream; and
associating the user device with one of the second user device or the third user device, based on receiving a reply to the query from the user that associates the comment input device to a corresponding one of the addressable media stream or the second addressable media stream.

6. The method of claim 4, wherein the determined proximity is based on at least one of radio frequency (RF) proximity, network address prefix proximity, or determined geographic proximity.

7. The method of claim 1, further comprising the server causing the comment to be presented concurrently with the addressable media stream at the identified position, for consumption of the comment at the identified position by a second user viewing the addressable media stream.

8. The method of claim 1, wherein the generating includes:
determining an affinity by the user toward the event based on interpreting the comment relative to the event; and
inserting within the media comment message an item affinity value that quantifies the affinity by the user toward at least one attribute of the event.

9. The method of claim 1, wherein the comment is a media file, the generating including at least one of supplying the comment in a form of the media file, or supplying the comment in the form of text translated from the media file.

10. The method of claim 1,further comprising:
collecting, by the server from a second user device, a second comment input by a second user into the second user device, the collecting of the second comment including identifying the second user and the time that the second user generated the second comment;
associating by the server the second comment with the identifiable addressable media stream and at a second identified position within the addressable media stream coincident with the time the second user generated the second comment; and
generating and outputting by the server a second media comment message that identifies the second user, the second comment, the addressable media stream and the second identified position, the first and second media comment messages output to a prescribed destination for collection of the respective first and second comments relative to the addressable media stream.

11. An apparatus comprising:
a device interface circuit configured for collecting, from a user device, a comment input by a user into the user device; and
a processor circuit configured for:
identifying the user and a time that the user generated the comment, associating the comment input by the user with an identifiable addressable media stream and at an identified position within the addressable media stream that is coincident with the time that the user generated the comment relative to an event presented in the addressable media stream, and
generating a media comment message that identifies the user, the comment generated by the user, the addressable media stream and the identified position within the addressable media stream coinciding with the time that the user generated the comment;
the device interface circuit configured for outputting the media comment message to a prescribed destination.

12. The apparatus of claim 11, wherein the processor circuit is configured for associating the comment with the event based on:
registering the user, via the user device, as witnessing a live event; and
identifying the addressable media stream as a broadcast of the live event;
the processor circuit configured for identifying the time that the user generated the comment based on detecting a timestamp value supplied with the comment from the user device and identifying the time that the user generated the comment.

13. The apparatus of claim 11, wherein the processor circuit is configured for associating the comment with the event based on detecting that the user is viewing the addressable media stream via a second user device distinct from the user device.

14. The apparatus of claim 13, wherein the processor circuit is configured for associating the user device as a comment input device for the addressable media stream supplied to the second user device, based on identifying a determined proximity between the user device and the second user device as the addressable media stream is supplied to the second user device.

15. The apparatus of claim 14, wherein the processor circuit is configured for:
detecting a second addressable media stream supplied to a third user device within the determined proximity between the user device and the second user device;
sending a query to the user for associating the user device as the comment input device for one of the addressable media stream or the second addressable media stream; and
associating the user device with one of the second user device or the third user device, based on receiving a reply to the query from the user that associates the comment input device to a corresponding one of the addressable media stream or the second addressable media stream.

16. The apparatus of claim 14, wherein the determined proximity is based on at least one of radio frequency (RF) proximity, network address prefix proximity, or determined geographic proximity.

17. The apparatus of claim 11, wherein the processor circuit is configured for causing the comment to be presented concurrently with the addressable media stream at the identified position, for consumption of the comment at the identified position by a second user viewing the addressable media stream.

18. The apparatus of claim 11, wherein the processor circuit is configured for determining an affinity by the user toward the event based on interpreting the comment relative to the event, and inserting within the media comment message an item affinity value that quantifies the affinity by the user toward at least one attribute of the event.

19. The apparatus of claim 11, wherein the comment is a media file, the processor circuit configured for supplying the comment in the media comment message in a form of at least one of the media file, or text translated from the media file.

20. The apparatus of claim 19, wherein:
the device interface circuit further is configured for collecting, from a second user device, a second comment input by a second user into the second user device;
the processor circuit further configured for identifying the second user and the time that the second user generated the second comment, the processor circuit further configured for associating the second comment with the identifiable addressable media stream and at a second identified position within the addressable media stream coincident with the time the second user generated the second comment, and generating a second media comment message that identifies the second user, the second comment, the addressable media stream and the second identified position, the first and second media comment messages output to a prescribed destination for collection of the respective first and second comments relative to the addressable media stream.

21. Logic encoded in one or more tangible media for execution and when executed operable for:
collecting, from a user device, a comment input by a user into the user device, the collecting including identifying the user and a time that the user generated the comment;
associating the comment input by the user with an identifiable addressable media stream and at an identified position within the addressable media stream that is coincident with the time that the user generated the comment relative to an event presented in the addressable media stream; and
generating and outputting a media comment message that identifies the user, the comment generated by the user, the addressable media stream and the identified position within the addressable media stream coinciding with the time that the user generated the comment.

22. An apparatus comprising:
means for collecting, from a user device, a comment input by a user into the user device; and
means for identifying the user and a time that the user generated the comment, the means for identifying further configured for associating the comment input by the user with an identifiable addressable media stream and at an identified position within the addressable media stream that is coincident with the time that the user generated the comment relative to an event presented in the addressable media stream;
the means for identifying further configured for generating a media comment message that identifies the user, the comment generated by the user, the addressable media stream and the identified position within the addressable media stream coinciding with the time that the user generated the comment;
the means for collecting further configured for outputting the media comment message to a prescribed destination.

23. An apparatus comprising:
a media controller circuit configured for causing an addressable media stream to be presented to a user of the apparatus from a media source that is distinct from the apparatus;
a comment input key responsive to input pressure by the user;
a comment circuit configured for identifying the user and recording a comment input by the user in response to detecting the input pressure of the comment input key by the user, the comment circuit configured for generating a comment message identifying the user and containing the comment; and
a device interface circuit configured for outputting the comment message to a prescribed destination that associates the comment with an event presented in the addressable media stream and that is coincident with a time that the user input the comment.

24. The apparatus of claim 23, wherein:
the device interface circuit is configured for retrieving the addressable media stream from a tangible storage medium accessible by the apparatus and that stores the media source;
the apparatus further comprising a media player circuit configured for presenting the addressable media stream to the user based on controls from the media controller circuit.

25. The apparatus of claim 23, further comprising an association circuit configured for implementing said prescribed destination that associates the comment with an event presented in the addressable media stream and that is coincident with a time that the user input the comment, the association circuit further configured for generating and outputting a media comment message that identifies the user, the comment generated by the user, the addressable media stream and an identified position within the addressable media stream coinciding with the event and the time that the user input the comment.

26. The apparatus of claim 25, wherein:
the device interface circuit is configured for collecting, from a user device distinct from the apparatus, a second comment input by a second user into a user device;
the association circuit is configured for identifying the second user and the time that the second user generated the second comment, the association circuit further configured for associating the second comment with the identifiable addressable media stream and at a second identified position within the addressable media stream coincident with the time a second user generated the second comment, and generating a second media comment message that identifies the second user, the second comment, the addressable media stream and the second identified position, the media comment message and the second media comment message output to a prescribed destination for collection of the respective first and second comments relative to the addressable media stream.

27. An apparatus comprising:
means for causing an addressable media stream to be presented to a user of the apparatus from a media source that is distinct from the apparatus;
a comment input key responsive to input pressure by the user;
means for identifying the user and a comment input by the user in response to detecting the input pressure of the comment input key by the user; and generating a comment message identifying the user and containing the comment, and
means for outputting the comment message to a prescribed destination that associates the comment with an event presented in the addressable media stream and that is coincident with a time that the user input the comment.
